(19) United States
(12) Patent Application Publication
(10) Pub. No.: US 2014/0253765 A1
(43) Pub. Date: Sep. 11, 2014

(54) SIGNAL PROCESSING UNIT, SOLID-STATE IMAGE PICKUP UNIT, ELECTRONIC APPARATUS, SIGNAL PROCESSING METHOD, AND PROGRAM

(71) Applicant: Sony Corporation, Tokyo (JP)

(72) Inventors: Kaneyoshi Takeshita, Tokyo (JP); Kazuki Nomoto, Kanagawa (JP); Kenichi Nishio, Kanagawa (JP)

(73) Assignee: SONY CORPORATION, Tokyo (JP)

(21) Appl. No.: 14/182,585

(22) Filed: Feb. 18, 2014

(30) Foreign Application Priority Data
Mar. 6, 2013 (JP) 2013-043886

(51) Int. Cl. H04N 5/357

(52) U.S. Cl. CPC H04N 5/357
USPC 348/250

(57) ABSTRACT

A signal processing unit includes: an extraction section configured to extract variation between a plurality of sampling values obtained through a plurality of sampling operations of signal levels in one or both of a first state and a second state, the first state being a state where floating diffusion is reset, the floating diffusion temporarily accumulating charges transferred from a photodiode performing photoelectric conversion, and the second state being a state where charges generated in the photodiode are accumulated in the floating diffusion; and a comparison section configured to compare the variation extracted by the extraction section and a predetermined reference value, and to switch, based on a result of the comparison, a signal to be output to a processing section in a subsequent stage.

### CROSS REFERENCE TO RELATED APPLICATIONS

This application claims the benefit of Japanese Priority Patent Application JP 2013-043886 filed Mar. 6, 2013, the entire contents of which are incorporated herein by reference.

### BACKGROUND

The present disclosure relates to a signal processing unit, a solid-state image pickup unit, an electronic apparatus, a signal processing method, and a program, and particularly relates to a signal processing unit, a solid-state image pickup unit, an electronic apparatus, a signal processing method, and a program that are capable of acquiring a signal suitable for noise reduction processing.

In an existing electronic apparatus having an image pickup function, such as a digital still camera and a video camcorder, for example, a solid-state image pickup device such as a charge coupled device (CCD) image sensor or a complementary metal oxide semiconductor (CMOS) image sensor has been used. The solid-state image pickup device has a pixel including a combination of a photodiode performing photoelectric conversion and a plurality of transistors. A signal output from the pixel is subjected to signal processing in an analog circuit or a memory LSI (Large Scale Integration).

For example, correlated double sampling (CDS) processing may be performed, as signal processing for acquiring a low-noise signal, on a signal output from the pixel. In the CDS method, a signal level in a state (P phase) before data input (of no signal) and a signal level in a state (D phase) after data input are sampled, and a difference between sampling values of such signal levels is obtained by a differential amplifier or digital calculation after AD conversion to remove noise. Such CDS processing is widely used to achieve a highly sensitive sensor.

For example, Japanese Unexamined Patent Application Publication No. H10-191169 (JP-A-H10-191169) discloses a method of reducing noise to 1/√2 of the original by performing sampling twice in each of the P phase and the D phase.

### SUMMARY

In the method of the above-described JP-A-H10-191169, CDS processing is performed using a difference between an average of sampling values in the P phase and an average of sampling values in the D phase. However, it is estimated that when a signal cycle is relatively long, noise may not be optimally reduced by simply using the average. Specifically, in such a method of performing a plurality of sampling operations, a signal that is unsuitable for the CDS processing may be acquired due to an increased sampling period. This causes a pixel value obtained by the CDS processing to be disadvantageously deviated from a true value.

It is desirable to acquire a signal that is more suitable for performing noise reduction processing.

According to an embodiment of the present disclosure, there is provided a signal processing unit, including: an extraction section configured to extract variation between a plurality of sampling values obtained through a plurality of sampling operations of signal levels in one or both of a first state and a second state, the first state being a state where floating diffusion is reset, the floating diffusion temporarily accumulating charges transferred from a photodiode performing photoelectric conversion, and the second state being a state where charges generated in the photodiode are accumulated in the floating diffusion; and a comparison section configured to compare the variation extracted by the extraction section and a predetermined reference value, and to switch, based on a result of the comparison, a signal to be output to a processing section in a subsequent stage.

According to an embodiment of the present disclosure, there is provided a solid-state image pickup unit, including: a pixel array including pixels arranged in arrays, each pixel having a photodiode performing photoelectric conversion and floating diffusion that temporarily accumulates charges transferred from the photodiode; a sampling section configured to sample a signal level in a first state and a signal level in a second state, the first state being a state where the floating diffusion is reset, and the second state being a state where charges generated in the photodiode are accumulated in the floating diffusion; an extraction section configured to extract variation between a plurality of sampling values obtained through a plurality of sampling operations of the signal levels in one or both of the first state and the second state; and a comparison section configured to compare the variation extracted by the extraction section and a predetermined reference value, and to switch, based on a result of the comparison, a signal to be output to a processing section in a subsequent stage.

According to an embodiment of the present disclosure, there is provided an electronic apparatus including a solid-state image pickup unit, the solid-state image pickup unit including: a pixel array including pixels arranged in arrays, each pixel having a photodiode performing photoelectric conversion and floating diffusion that temporarily accumulates charges transferred from the photodiode; a sampling section configured to sample a signal level in a first state and a signal level in a second state, the first state being a state where the floating diffusion is reset, and the second state being a state where charges generated in the photodiode are accumulated in the floating diffusion, an extraction section configured to extract variation between a plurality of sampling values obtained through a plurality of sampling operations of the signal levels in one or both of the first state and the second state; and a comparison section configured to compare the variation extracted by the extraction section and a predetermined reference value, and to switch, based on a result of the comparison, a signal to be output to a processing section in a subsequent stage.

According to an embodiment of the present disclosure, there is provided a signal processing method, including: extracting variation between a plurality of sampling values obtained through a plurality of sampling operations of signal levels in one or both of a first state and a second state, the first state being a state where floating diffusion is reset, the floating diffusion temporarily accumulating charges transferred from a photodiode performing photoelectric conversion, and the second state being a state where charges generated in the photodiode are accumulated in the floating diffusion; and comparing the extracted variation and a predetermined reference value, and switching, based on a result of the comparison, a signal to be output to a processing section in a subsequent stage.

According to an embodiment of the present disclosure, there is provided a non-transitory tangible recording medium having a program embodied therein, the computer-readable program allowing, when executed by a computer, the computer to execute signal processing, the signal processing including: extracting variation between a plurality of sampling values obtained through a plurality of sampling operations of signal levels in one or both of a first state and a second state, the first state being a state where floating diffusion is reset, the floating diffusion temporarily accumulating charges transferred from a photodiode performing photoelectric conversion, and the second state being a state where charges generated in the photodiode are accumulated in the floating diffusion; and comparing the extracted variation and a predetermined reference value, and switching, based on a result of the comparison, a signal to be output to a processing section in a subsequent stage.

In any of the above-described respective embodiments of the present disclosure, variation between a plurality of sampling values obtained through a plurality of sampling operations of signal levels in one or both of a first state and a second state is extracted, the first state being a state where floating diffusion is reset, the floating diffusion temporarily accumulating charges transferred from a photodiode performing photoelectric conversion, and the second state being a state where charges generated in the photodiode are accumulated in the floating diffusion, and the extracted variation is compared with a predetermined reference value, and a signal to be output to a processing section in a subsequent stage is switched based on a result of the comparison.

According to any of the above-described respective embodiments of the present disclosure, a signal that is more suitable for performing noise reduction processing is allowed to be acquired.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIGS. 1A and 1B are diagrams explaining existing CDS processing.

FIG. 2 is a block diagram illustrating an exemplary configuration of an embodiment of a solid-state image pickup unit to which the present technology is applied.

FIG. 3 is a diagram illustrating a relationship between a sampling cycle and a noise cycle.

FIG. 4 is a block diagram illustrating a first exemplary configuration of a data processing section.

FIG. 5 is a flowchart explaining data processing.

FIG. 6 is a flowchart explaining data processing.

FIG. 7 is a diagram explaining that distribution or a cycle of noise varies depending on a noise type.

FIG. 8 is a diagram illustrating a relationship of a sampling cycle and a noise cycle.

FIG. 9 is a block diagram illustrating a second exemplary configuration of the data processing section.

FIG. 10 is a flowchart explaining data processing.

FIG. 11 is a block diagram illustrating a second exemplary configuration of the image pickup device.

FIG. 12 is a block diagram illustrating a third exemplary configuration of the image pickup device.

FIG. 13 is a block diagram illustrating an exemplary configuration of an image pickup unit to be mounted in an electronic apparatus.

### DETAILED DESCRIPTION

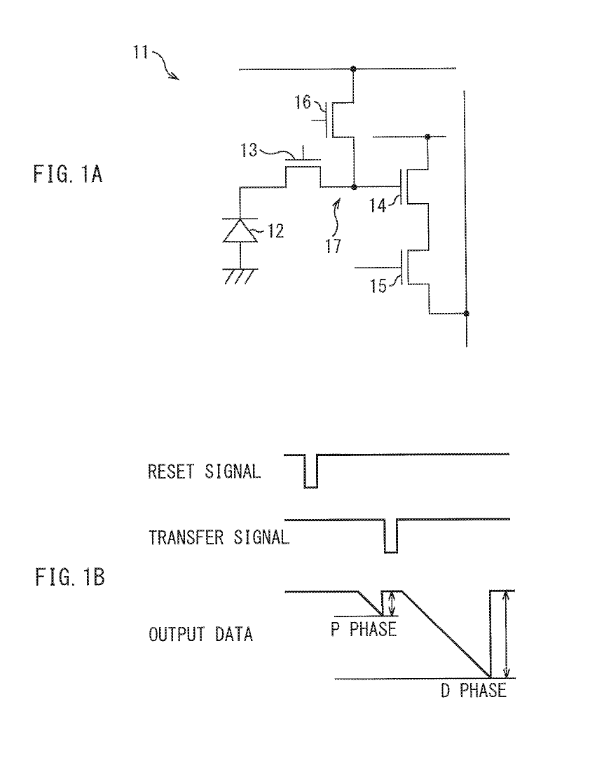

First, existing CDS processing is described with reference to FIGS. 1A and 1B.

FIG. 1A illustrates an exemplary configuration of a pixel having four transistors. FIG. 1B illustrates a signal received by the pixel and data output from the pixel.

As illustrated in FIG. 1A, a pixel 11 is configured of a combination of a photodiode 12, a transfer transistor 13, an amplifying transistor 14, a selection transistor 15, and a reset transistor 16. In the pixel 11, a floating diffusion (FD) section 17 that temporarily accumulates charges generated in the photodiode 12 is provided in a connection at which the transfer transistor 13 is connected to a gate electrode of the amplifying transistor 14.

In the CDS processing, first, a reset signal that is to drive the reset transistor 16 is turned on in a pulsed manner, thereby charges accumulated in the FD section 17 are discharged via the reset transistor 16, so that a signal level in a P phase is sampled. Subsequently, a transfer signal that is to drive the transfer transistor 13 is turned on in a pulsed manner, thereby a charge generated in the photodiode 12 is transferred to the FD section 17 via the transfer transistor 13, so that a signal level in a D phase is sampled.

In this method, temporally highly-correlated noise is allowed to be cancelled by shortening a sampling cycle Ts corresponding to an interval between sampling timing of a signal level in the P phase and sampling timing of a signal level in the D phase. However, if a cycle Tn of randomly generated random noise is longer than the sampling cycle Ts, noise correlation is reduced, and therefore a noise reduction effect is reduced.

Thus, there has been proposed a technique where signal levels are sampled two or more times in each of the P phase and the D phase for averaging of noise to allow a sampling value to be similar to a true value. Noise superposition with multiple sampling is represented by the square sum. Hence, when sampling is performed two times, and if noise in first sampling is denoted by V1, and noise in second sampling is denoted by V2, superposed noise Vn (total noise) is represented by the following Formula (1).

[Numerical Expression 1]

Vₙ(total)=\sqrt{(V₁²+V₂²)} (1)

In this case, when an output level is denoted by x, output of the multiple sampling is represented by the following Formula (2).

$$\begin{matrix}[ Numerical Expression 2 ] & \\ \frac{\sqrt{( {x}^{2} + {x}^{2} )}}{2} = \frac{x \sqrt{2}}{2} & ( 2 )\end{matrix}$$

In this way, each component is sampled two times and added to each other, thereby although the standard deviation of a noise component increases √2 times, the amplitude of the noise component increases twice. As a result, the signal noise (SN) ratio is increased by √2 times. In addition, even if the SN ratio is decreased to about 1/√2 of the original, an initial SN ratio is eventually maintained by performing subtraction in a subsequent stage.

It is estimated that when a signal cycle is relatively long, and even if such multiple sampling is performed, noise may not be optimally reduced by simply using the average as described above. Thus, a signal that is more suitable for performing noise reduction processing is necessary to be acquired.

Hereinafter, some specific embodiments to which the present technology is applied are described in detail with reference to the accompanying drawings.

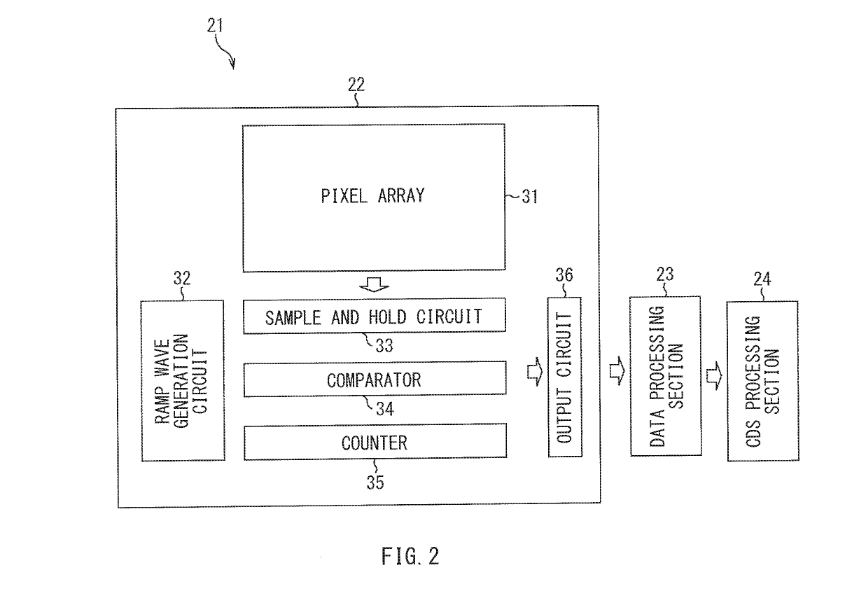

FIG. 2 is a block diagram illustrating an exemplary configuration of an embodiment of a solid-state image pickup unit to which the present technology is applied.

In FIG. 2, a solid-state image pickup unit 21 includes an image pickup device 22, a data processing section 23, and a CDS processing section 24. For example, the data processing section 23 and the CDS processing section 24 may each be configured of a digital signal processor (DSP). In the solid-state image pickup unit 21, a sampling value output from the image pickup device 22 is subjected to data processing in the data processing section 23, and subjected to CDS processing in the CDS processing section 24.

The image pickup device 22 includes a pixel array 31, a ramp wave generation circuit 32, a sample and hold circuit 33, a comparator 34, a counter 35, and an output circuit 36.

The pixel array 31 is configured of a plurality of pixels (for example, the pixels 11 in FIG. 1A) arranged in arrays, each pixel outputting a pixel signal corresponding to light received by that pixel.

The ramp wave generation circuit 32 generates a signal having a waveform of a ramp wave to be used for comparison in the comparator 34, for example, a signal having a waveform of a voltage falling at a constant gradient.

The sample and hold circuit 33 holds a signal level of a pixel signal output from each pixel of the pixel array 31. For example, a pixel signal in a state (P phase) where the FD section 17 is reset, and a pixel signal in a state (D phase) where charges generated in the photodiode 12 are accumulated in the FD section 17 are each output two or more times from the pixel 11 in FIG. 1, and the sample and hold circuit 33 holds the signal level in each of the P phase and the D phase at timing corresponding to each signal level.

The comparator 34 compares a signal level of the pixel signal held by the sample and hold circuit 33 and a level of the ramp wave output from the ramp wave generation circuit 32. In addition, when a result of the comparison is changed, the comparator 34 outputs a signal indicating such change to the counter 35 at timing when the change occurs, for example, at timing when the level of the ramp wave becomes equal to or lower than the signal level of the pixel signal.

The counter 35 counts a voltage value from the timing of start of falling of a voltage of the ramp wave output from the ramp wave generation circuit 32 to the timing of change in comparison result by the comparator 34, and outputs the counted value as a signal level of the pixel signal.

The output circuit 36 amplifies the signal level output from the counter 35 with a predetermined amplification factor, and outputs the amplified signal level. For example, when the sample and hold circuit 33 holds the pixel signal in each of the P phase and the D phase two or more times as described above, the output circuit 36 outputs the signal level in each of the P phase and the D phase two or more times.

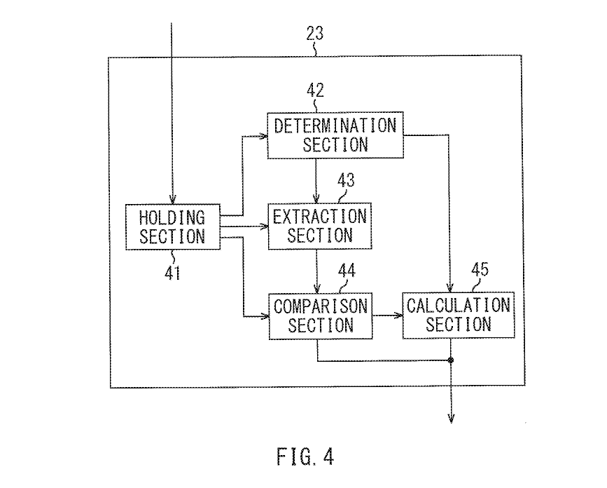

The data processing section 23 performs data processing based on the signal level in each of the P phase and the D phase output from the output circuit 36 so as to acquire a signal to be used for CDS processing performed by the CDS processing section 24. The configuration of the data processing section 23 is described later with reference to FIG. 4.

The CDS processing section 24 performs CDS processing using the signal acquired by the data processing section 23, and thus outputs the pixel signal while appropriately reducing noise contained in the pixel signal.

In this way, in the solid-state image pickup unit 21, the signal level in each of the P phase and the D phase is sampled two or more times. Description is now made on processing performed based on a sampling value obtained by performing sampling of the signal level two times in each of the P phase and the D phase.

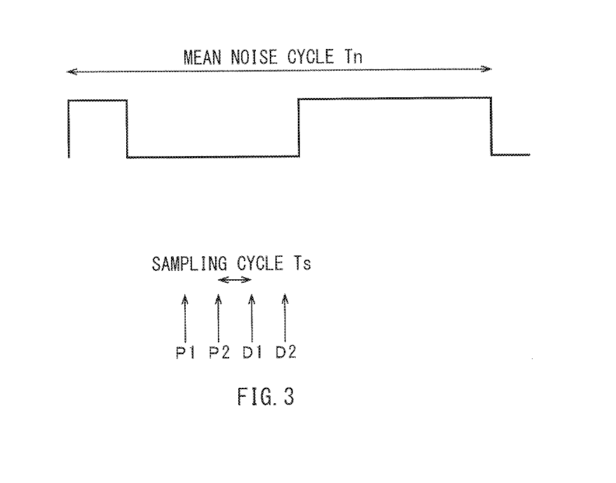

For example, as illustrated in FIG. 3, the solid-state image pickup unit 21 may perform sampling with an interval of the sampling cycle Ts. As a result, a first sampling value P1 in the P phase, a second sampling value P2 in the P phase, a first sampling value D1 in the D phase, and a second sampling value D2 in the D phase are output from the image pickup device 22 to the data processing section 23. A ratio of a mean noise cycle Tn to the sampling cycle Ts is defined as cycle ratio ε (=Ts/Tn).

FIG. 4 is a block diagram illustrating a first exemplary configuration of the data processing section 23.

As illustrated in FIG. 4, the data processing section 23 includes a holding section 41, a determination section 42, an extraction section 43, a comparison section 44, and a calculation section 45.

The holding section 41 sequentially receives the sampling values output from the image pickup device 22, i.e., the sampling value P1, the sampling value P2, the sampling value D1, and the sampling value D2, and holds such sampling values.

The determination section 42 determines whether the sampling value P1 is equal to the sampling value P2 or not. Furthermore, the determination section 42 determines whether the sampling value D1 is equal to the sampling value D2 or not.

When the determination section 42 determines the sampling value P1 is not equal to the sampling value P2, the extraction section 43 extracts variation ΔP between the sampling value P1 and the sampling value P2. When the determination section 42 determines the sampling value D1 is not equal to the sampling value D2, the extraction section 43 extracts variation ΔD between the sampling value D1 and the sampling value D2.

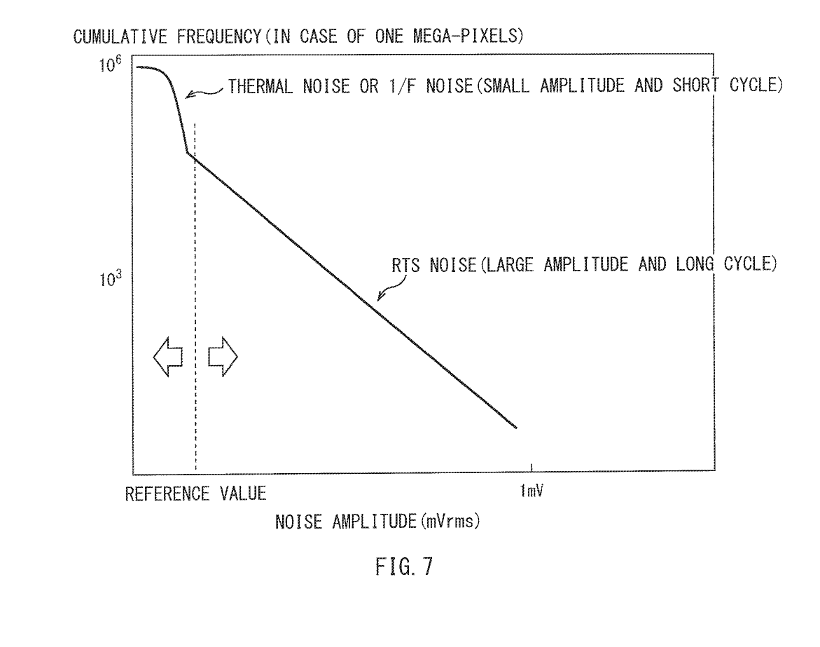

The comparison section 44 compares the variation ΔP extracted by the extraction section 43 and a predetermined reference value. When the variation ΔP is larger than the reference value as a result of such comparison, the comparison section 44 outputs the sampling value P2 to the CDS processing section 24. In addition, the comparison section 44 compares the variation ΔD extracted by the extraction section 43 and a predetermined reference value. When the variation ΔD is larger than the reference value as a result of such comparison, the comparison section 44 outputs the sampling value D1 to the CDS processing section 24. It is to be noted that the predetermined reference value used for the comparison by the comparison section 44 is described later with reference to FIG. 7.

Based on the determination result of the determination section 42 and the comparison result of the comparison section 44, the calculation section 45 calculates an average of the sampling value P1 and the sampling value P2, and outputs the average to the CDS processing section 24. Specifically, when the sampling value P1 is determined to be equal to the sampling value P2, or the variation ΔP is smaller than the reference value, the calculation section 45 calculates the average of the sampling value P1 and the sampling value P2, and outputs the average to the CDS processing section 24.

Similarly, based on the determination result of the determination section 42 and the comparison result of the comparison section 44, the calculation section 45 calculates an average of the sampling value D1 and the sampling value D2, and outputs the average to the CDS processing section 24. Specifically, when the sampling value D1 is determined to be equal to the sampling value D2, or the variation ΔD is smaller than the reference value, the calculation section 45 calculates the average of the sampling value D1 and the sampling value D2, and outputs the average to the CDS processing section 24.

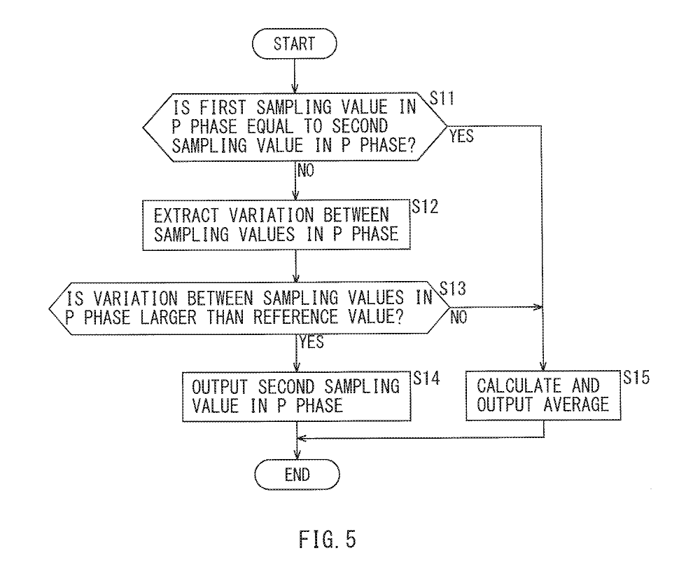

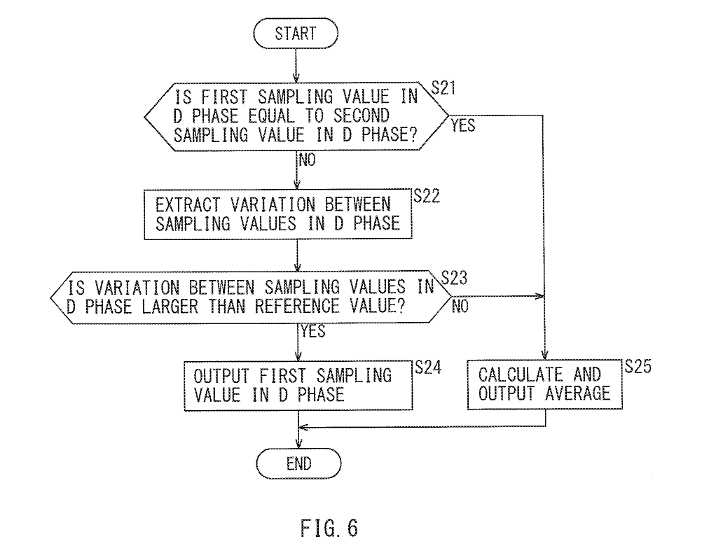

FIGS. 5 and 6 are each a flowchart explaining data processing by the data processing section 23.

For example, when the sampling value P1 and the sampling value P2 are held by the holding section 41, a process of the flowchart of FIG. 5 is started.

In step S11, the determination section 42 reads the sampling value P1 and the sampling value P2 held by the holding section 41, and determines whether the sampling value P1 is equal to the sampling value P2 or not.

If the determination section 42 determines the sampling value P1 is not equal to the sampling value P2 (P1≠P2) in step S11, the process advances to step S12.

In step S12, the determination section 42 informs the extraction section 43 that the sampling value P1 is not equal to the sampling value P2. In response to this, the extraction section 43 reads the sampling value P1 and the sampling value P2 held by the holding section 41, and extracts variation ΔP between the sampling value P1 and the sampling value P2, and supplies the variation ΔP to the comparison section 44.

In step S13, the comparison section 44 compares the variation ΔP supplied from the extraction section 43 and a predetermined reference value, and determines whether the variation ΔP is larger than the reference value or not.

If the comparison section 44 determines the variation ΔP is larger than the reference value in step S13, the process advances to step S14, and the comparison section 44 reads the sampling value P2 from the holding section 41, and outputs the sampling value P2 to the CDS processing section 24.

On the other hand, if the determination section 42 determines the sampling value P1 is equal to the sampling value P2 (P1=P2) in step S11, or if the comparison section 44 determines the variation ΔP is not larger than (equal to or smaller than) the reference value in step S13, the process advances to step S15.

In step S15, the calculation section 45 calculates an average ((P1+P2)/2) of the sampling value P1 and the sampling value P2, and outputs the average to the CDS processing section 24.

After the processing of step S14 or S15, the process is finished. Subsequently, for example, when the sampling value D1 and the sampling value D2 are held by the holding section 41, a process of the flowchart of FIG. 6 is started.

In step S21, the determination section 42 reads the sampling value D1 and the sampling value D2 held by the holding section 41, and determines whether the sampling value D1 is equal to the sampling value D2 or not.

If the determination section 42 determines the sampling value D1 is not equal to the sampling value D2 (D1≠D2) in step S21, the process advances to step S22.

In step S22, the determination section 42 informs the extraction section 43 that the sampling value D1 is not equal to the sampling value D2. In response to this, the extraction section 43 reads the sampling value D1 and the sampling value D2 held by the holding section 41, and extracts variation ΔD between the sampling value D1 and the sampling value D2, and supplies the variation ΔD to the comparison section 44.

In step S23, the comparison section 44 compares the variation ΔD supplied from the extraction section 43 and a predetermined reference value, and determines whether the variation ΔD is larger than the reference value or not.

If the comparison section 44 determines the variation ΔD is larger than the reference value in step S23, the process advances to step S24, and the comparison section 44 reads the sampling value D1 from the holding section 41, and outputs the sampling value D1 to the CDS processing section 24.

On the other hand, if the determination section 42 determines the sampling value D1 is equal to the sampling value D2 (D1=D2) in step S21, or if the comparison section 44 determines the variation ΔD is not larger than (equal to or smaller than) the reference value in step S23, the process advances to step S25.

In step S25, the calculation section 45 calculates an average ((D1+D2)/2) of the sampling value D1 and the sampling value D2, and outputs the average to the CDS processing section 24.

After the processing of step S24 or S25, the process is finished.

As described above, based on the sampling value P1, the sampling value P2, the sampling value D1, and the sampling value D2, the data processing section 23 switches the signal to be output from the data processing section 23 such that a signal suitable for CDS processing is output. Consequently, the CDS processing section 24 is allowed to obtain a pixel signal having a value similar to a true value.

This is because a random noise causing a sampling value to vary beyond a certain level is often caused by an interface trap, etc., and therefore a time constant of the noise distributes over a certain area.

A fact that distribution or a cycle of noise varies depending on a noise type is now described with reference to FIG. 7.

FIG. 7 illustrates distribution of cumulative frequency of noise against amplitude of the noise. For example, the vertical axis may indicate the cumulative frequency of noise occurrence in logarithms in the case where the number of pixels of the pixel array 31 is one mega pixels, and the horizontal axis may indicate root mean square (rms) of the noise amplitude (mV).

As illustrated in FIG. 7, when the noise amplitude is equal to or smaller than a certain level (a level indicated by a broken line in FIG. 7), a thermal noise or 1/f noise having a small amplitude and a short cycle is generated. On the other hand, when the noise amplitude is equal to or larger than the certain level, a random telegraph signal (RTS) noise having a large amplitude and a long cycle is generated.

FIG. 7 shows that when a sampling interval of CDS processing is set sufficiently smaller than a noise time constant, variations occur at a lower probability within a period from first sampling in the P phase to last sampling in the D phase. Hence, if a variation occurs in the P phase or the D phase, a signal to be used for CDS processing is changed from the average to a sampling value in the P phase or D phase, thereby a pixel signal having a value similar to a true value is allowed to be obtained in the CDS processing compared with a case of using the average.

Thus, in the solid-state image pickup unit 21, a level at which noise amplitude is varied depending on a noise type (a level indicated by a broken line in FIG. 7) is set as a reference value to be used for comparison by the comparison section 44. For example, 1.0 mV or 0.3 mV may be set as the reference value.

When the variation ΔP is equal to or smaller than the reference value, the data processing section 23 outputs the average of the sampling value P1 and the sampling value P2 as a signal to be used by the CDS processing section 24. When the variation ΔP is larger than the reference value, the data processing section 23 outputs the sampling value P2 as the signal. Similarly, when the variation ΔD is equal to or smaller than the reference value, the data processing section 23 outputs the average of the sampling value D1 and the sampling value D2 as a signal to be used by the CDS processing section 24. When the variation ΔD is larger than the reference value, the data processing section 23 outputs the sampling value D1 as the signal.

Consequently, the CDS processing section 24 is allowed to perform CDS processing using a signal that is more suitable for performing the CDS processing, and is thus allowed to acquire a low-noise pixel value similar to a true value.

For example, in existing CDS processing, when a cycle ratio ε as a ratio of the mean noise cycle Tn to the sampling cycle Ts is sufficiently smaller than 1, noise σ2 satisfies σ2=ε, and when the cycle ratio ε is sufficiently larger than 1, noise σ2 satisfies σ2=½. Specifically, in multiple CDS, in the case of a long cycle noise where the cycle ratio ε is sufficiently smaller than 1, the noise σ2 becomes 3/2 of that in the existing CDS processing, i.e., noise is disadvantageously increased. In the multiple CDS, in the case of a short cycle noise where the cycle ratio E is sufficiently larger than 1, the noise σ2 becomes ¼, i.e., the noise σ2 is decreased to ½ of that in the existing CDS processing.

Thus, the data processing by the data processing section 23 makes it possible to overcome a difficulty of the multiple CDS, i.e., to avoid the reduction in noise suppression effect on the long cycle noise having a cycle ratio ε that is sufficiently smaller than 1. Specifically, the solid-state image pickup unit 21 is allowed to achieve a noise suppression effect on the long cycle noise while maintaining the noise reduction effect on the short cycle noise at a level equal to a level in the existing CDS processing.

In the solid-state image pickup unit 21, while sampling of the signal level in each of the P phase and the D phase has been performed two times as describe above, the sampling of the signal level in each of the P phase and the D phase may be performed two or more times.

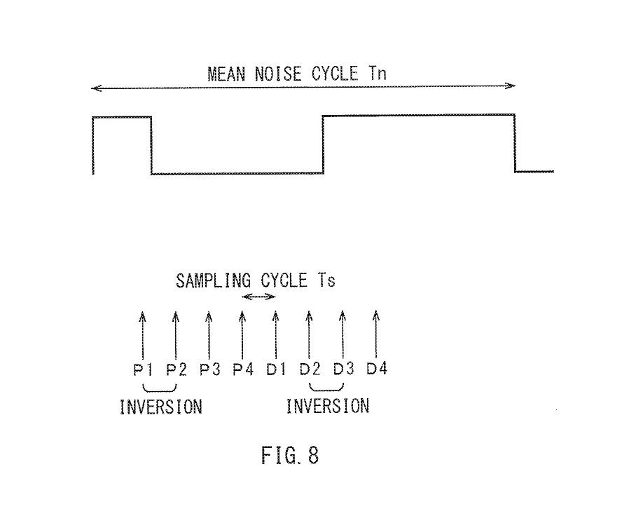

For example, FIG. 8 illustrates an exemplary case where sampling is performed four times in each of the P phase and the D phase with an interval of the sampling cycle Ts.

Consequently, a first sampling value P1 in the P phase, a second sampling value P2 in the P phase, a third sampling value P3 in the P phase, a fourth sampling value P4 in the P phase, a first sampling value D1 in the D phase, a second sampling value D2 in the D phase, a third sampling value D3 in the D phase, and a fourth sampling value D4 in the D phase are output from the image pickup device 22 to the data processing section 23.

In the case where sampling is performed two or more times in this way, since a sampling period is lengthened, random noise may affect the sampling. In the exemplary case of FIG. 8, random noise is inverted between the sampling value P1 and the sampling value P2, and between the sampling value D2 and the sampling value D3.

Thus, the data processing section 23 is allowed to perform data processing that allows a signal to be used for CDS processing to be switched depending on a frequency of state change occurring between sampling values in each phase.

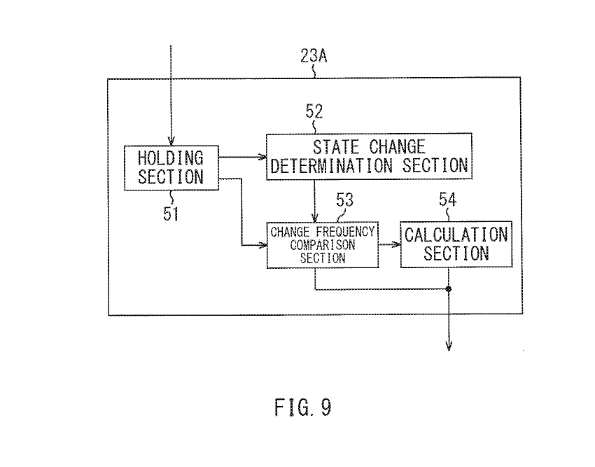

FIG. 9 is a block diagram illustrating a second exemplary configuration of the data processing section 23.

As illustrated in FIG. 9, a data processing section 23A includes a holding section 51, a state change determination section 52, a change frequency comparison section 53, and a calculation section 54.

The holding section 51 holds a sampling value output from the image pickup device 22. Specifically, the holding section 51 sequentially receives the sampling value P1, the sampling value P2, the sampling value P3, the sampling value P4, the sampling value D1, the sampling value D2, the sampling value D3, and the sampling value D4 from the image pickup device 22, and holds such sampling values.

The state change determination section 52 determines, based on consecutive sampling values in the same phase, whether or not state change occurs between sampling values in each phase. Specifically, the state change determination section 52 determines whether or not state change occurs between the sampling value P1 and the sampling value P2, whether or not state change occurs between the sampling value P2 and the sampling value P3, and whether or not state change occurs between the sampling value P3 and the sampling value P4. Similarly, the state change determination section 52 determines whether or not state change occurs between the sampling value D1 and the sampling value D2, whether or not state change occurs between the sampling value D2 and the sampling value D3, and whether or not state change occurs between the sampling value D3 and the sampling value D4.

In addition, the state change determination section 52 informs the change frequency comparison section 53 of a change frequency as a frequency at which state change is determined to occur.

The change frequency comparison section 53 compares the change frequency informed from the state change determination section 52 and a predetermined regular frequency. When the change frequency is lower than the regular frequency as a result of the comparison, the change frequency comparison section 53 outputs the sampling value P4 and the sampling value D1 to the CDS processing section 24. It is to be noted that an optimal value is beforehand selected, based on noise characteristics (for example, the mean noise cycle Tn) of the image pickup device 22, as the predetermined regular frequency to be used for the comparison by the change frequency comparison section 53.

When the change frequency is equal to or higher than the regular frequency as a result of the comparison by the change frequency comparison section 53, the calculation section 54 calculates an average of the sampling values P1 to P4 and an average of the sampling values D1 to D4, and outputs the averages to the CDS processing section 24.

Specifically, when the frequency of state change between consecutive sampling values in the same phase is not equal to or higher than the regular frequency, the data processing section 23A estimates that a noise cycle is large, and outputs the sampling value P4 and the sampling value D1 as signals to be used for CDS processing. On the other hand, when the frequency of state change between consecutive sampling values in the same phase is equal to or higher than the regular frequency, the data processing section 23A estimates that a noise cycle is small, and outputs the average of the sampling values in each phase as a signal to be used for CDS processing.

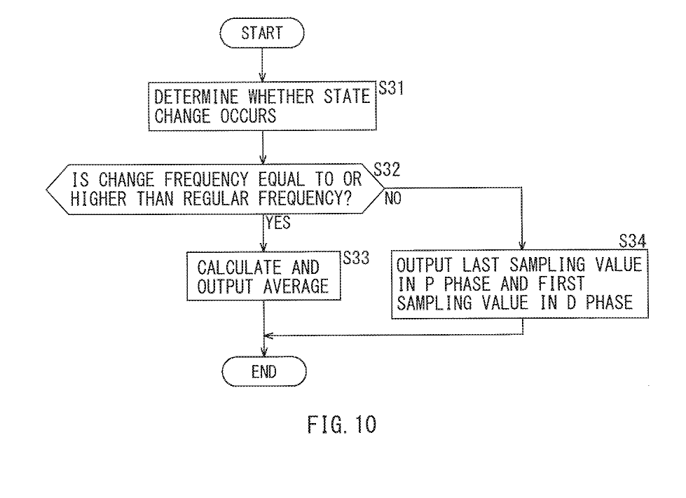

FIG. 10 is a flowchart explaining data processing by the data processing section 23A.

For example, when at least the sampling value P1 and the sampling value P2 are held by the holding section 41, a process of the flowchart of FIG. 10 is started. It is to be noted that the process may be started at timing where the sampling values P1 to P4 and the sampling values D1 to D4 are all held by the holding section 41.

In step S31, the state change determination section 52 determines, based on consecutive sampling values in the same phase, whether or not state change occurs between sampling values in each phase, and counts a change frequency as a frequency at which state change is determined to occur. The state change determination section 52 informs the change frequency comparison section 53 of a final change frequency obtained through determination on all the sampling values from the sampling value P1 to the sampling value D4.

In step S32, the change frequency comparison section 53 determines whether the change frequency informed from the state change determination section 52 in step 31 is equal to or higher than a regular frequency or not.

When the change frequency comparison section 53 determines that the change frequency is equal to or higher than the regular frequency in step S32, the process advances to step S33. In step S33, the calculation section 54 calculates an average ((P1+P2+P3+P4)/4) of the sampling values P1 to P4 and an average ((D1+D2+D3+D4)/4) of the sampling values D1 to D4, and outputs the averages to the CDS processing section 24.

On the other hand, when the change frequency comparison section 53 determines that the change frequency is not equal to or higher than (is lower than) the regular frequency in step S32, the process advances to step S34. In step S34, the change frequency comparison section 53 reads the sampling value D4 and the sampling value D1 from the holding section 51, and outputs such sampling values to the CDS processing section 24.

After the processing of step S33 or S34, the process is finished.

As described above, a high frequency (a frequency equal to or higher than the regular frequency) of state change between sampling values corresponds to short-cycle noise, and in such a case, as with existing multiple CDS, the data processing section 23A outputs the average of the sampling values in each phase, and is thus allowed to prioritize the improvement effect obtained by averaging noise. In addition, a low frequency (a frequency lower than the regular frequency) of state change between sampling values corresponds to long-cycle noise, and in such a case, as with existing CDS, the data processing section 23A is allowed to prioritize the improvement effect obtained by minimizing a sampling interval using one sampling value in each of the P phase and the D phase. In other words, the data processing by the data processing section 23A makes it possible to effectively reduce each of short-cycle noise and long-cycle noise, and thus makes it possible to improve characteristics.

In the solid-state image pickup unit 21, the image pickup device 22 may be configured such that data processing, which has been performed in the data processing section 23, is performed in the image pickup device 22, and the sampling value is output therefrom to the CDS processing section 24.

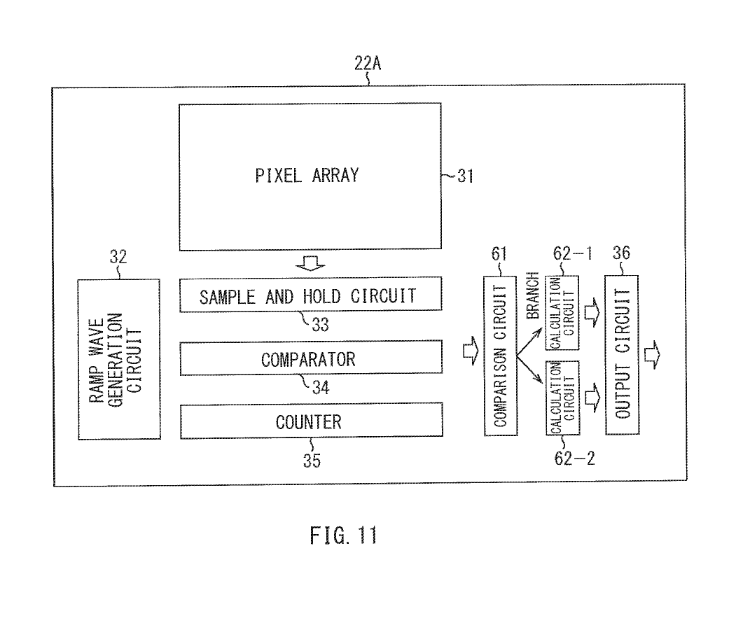

Specifically, FIG. 11 is a block diagram illustrating a second exemplary configuration of the image pickup device 22. In FIG. 11, blocks common to those in the image pickup device 22 in FIG. 2 are designated by the same numerals, and detailed description of them is omitted.

As illustrated in FIG. 11, an image pickup device 22A includes a pixel array 31, a ramp wave generation circuit 32, a sample and hold circuit 33, a comparator 34, a counter 35, an output circuit 36, a comparison circuit 61, and calculation circuits 62-1 and 62-2.

The comparison circuit 61 receives the sampling value P1 and the sampling value P2 from the counter 35, and performs a determination process and a comparison process as with the flowchart of FIG. 5. Specifically, when the sampling value P1 is equal to the sampling value P2, the comparison circuit 61 supplies the sampling value P1 and the sampling value P2 to the calculation circuit 62-1. When the sampling value P1 is not equal to the sampling value P2, the comparison circuit 61 extracts variation ΔP, and when the variation ΔP is smaller than a reference value, the comparison circuit 61 supplies the sampling value P1 and the sampling value P2 to the calculation circuit 62-1. On the other hand, when the variation ΔP is larger than the reference value, the comparison circuit 61 supplies the sampling value P1 and the sampling value P2 to the calculation circuit 62-2.

In this way, in the image pickup device 22A, the comparison circuit 61 supplies the sampling value P1 and the sampling value P2, which have been supplied from the counter 35, to one of the calculation circuit 62-1 and the calculation circuit 62-2 in a branched manner depending on magnitude of each value.

Similarly, the comparison circuit 61 receives the sampling value D1 and the sampling value D2 from the counter 35, and performs a determination process and a comparison process as with the flowchart of FIG. 6. Specifically, when the sampling value D1 is equal to the sampling value D2, the comparison circuit 61 supplies the sampling value D1 and the sampling value D2 to the calculation circuit 62-1. When the sampling value D1 is not equal to the sampling value D2, the comparison circuit 61 extracts variation ΔD, and when the variation ΔD is smaller than a reference value, the comparison circuit 61 supplies the sampling value D1 and the sampling value D2 to the calculation circuit 62-1. On the other hand, when the variation ΔD is larger than the reference value, the comparison circuit 61 supplies the sampling value D1 and the sampling value D2 to the calculation circuit 62-2.

In this way, in the image pickup device 22A, the comparison circuit 61 supplies the sampling value D1 and the sampling value D2, which have been supplied from the counter 35, to one of the calculation circuit 62-1 and the calculation circuit 62-2 in a branched manner depending on magnitude of each value.

The calculation circuit 62-1 calculates an average of the sampling value P1 and the sampling value P2 supplied from the comparison circuit 61, and outputs the average to the output circuit 36. Similarly, the calculation circuit 62-1 calculates an average of the sampling value D1 and the sampling value D2 supplied from the comparison circuit 61, and outputs the average to the output circuit 36.

The calculation circuit 62-2 outputs, to the output circuit 36, the sampling value P2 between the sampling value P1 and the sampling value P2 supplied from the comparison circuit 61. Similarly, the calculation circuit 62-2 outputs, to the output circuit 36, the sampling value D1 between the sampling value D1 and the sampling value D2 supplied from the comparison circuit 61.

The image pickup device 22A is configured as described above, and is also allowed to reduce noise as with the image pickup device 22.

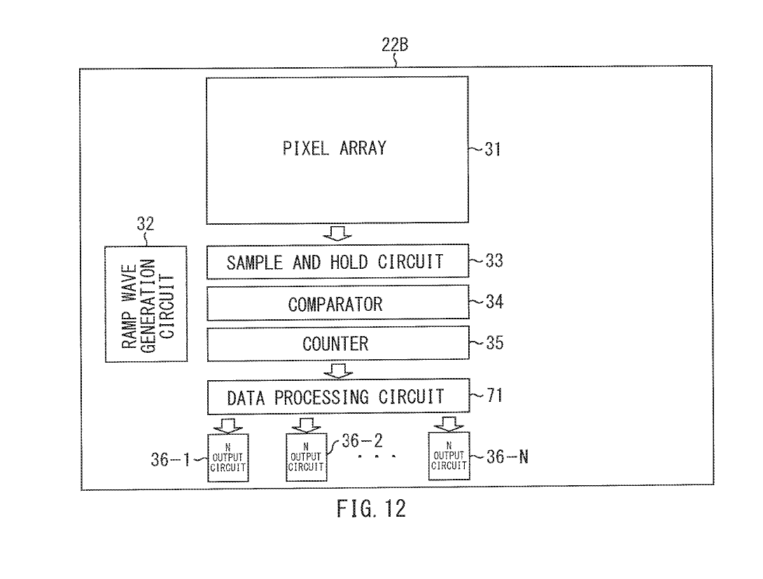

FIG. 12 is a block diagram illustrating a third exemplary configuration of the image pickup device 22. In FIG. 12, blocks common to those in the image pickup device 22 in FIG. 2 are designated by the same numerals, and detailed description of them is omitted.

As illustrated in FIG. 12, an image pickup device 22B includes a pixel array 31, a ramp wave generation circuit 32, a sample and hold circuit 33, a comparator 34, a counter 35, output circuits 36-1 to 36-N, and a data processing circuit 71.

The data processing circuit 71 has circuits (for example, the comparison circuit 61 and the calculation circuits 62-1 and 62-2 in FIG. 11) for performing data processing for each of pixel lines of the pixel array 31. Specifically, the data processing circuit 71 is allowed to perform data processing in parallel for each of pixel lines of the pixel array 31, and outputs signals for the individual pixel lines to the output circuits 36-1 to 36-N. Moreover, for example, the data processing circuit 71 and the output circuits 36-1 to 36-N are provided on a substrate to be stacked on a substrate on which the pixel array 31 is provided, thereby a stacked structure may be used for the image pickup device 22B.

The data processing circuit 71 receives the sampling value P1 and the sampling value P2 from the counter 35, and performs a determination process, a comparison process, and a calculation process as with the flowchart of FIG. 5. In addition, the data processing circuit 71 receives the sampling value D1 and the sampling value D2 from the counter 35, and performs a determination process, a comparison process, and a calculation process as with the flowchart of FIG. 6.

The image pickup device 22B is configured as described above, and is also allowed to reduce noise as with the image pickup device 22.

It is to be noted that although a plurality of sampling operations are performed in each of the P phase and the D phase in the above-described embodiments, the plurality of sampling operations may be performed in one or both of the P phase and the D phase. In this case, the noise reduction effect is also allowed to be obtained by performing the above-described data processing on signal levels in the phase subjected to the plurality of sampling operations.

For example, the sampling cycle Ts, in which the image pickup device 22 performs sampling of a signal level, may be set sufficiently smaller than the time constant of RTS noise generated by the transistors configuring the pixel 11. Consequently, even if a sampling frequency is increased, lengthening of a sampling period is avoided, and thus influence of the RTS noise is allowed to be suppressed.

The above-described solid-state image pickup unit 21 may be applied to any type of electronic apparatuses, for example, a camera system such as a digital still camera and a digital video camcorder, a mobile phone having an image pickup function, and other apparatuses having an image pickup function.

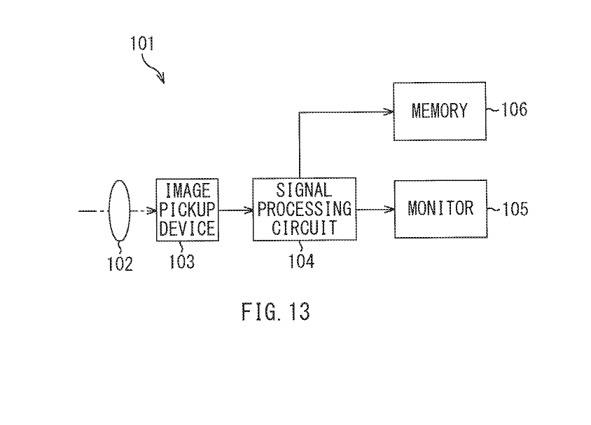

FIG. 13 is a block diagram illustrating an exemplary configuration of an image pickup unit to be mounted in an electronic apparatus

As illustrated in FIG. 13, an image pickup unit 101 includes an optical system 102, an image pickup device 103, a signal processing circuit 104, a monitor 105, and a memory 106, and is capable of capture a still image and a moving image.

The optical system 102 includes one or more lenses, and guides image light (incident light) from a subject to the image pickup device 103, and form an optical image on a light receiving surface (a sensor section) of the image pickup device 103.

The image pickup device 22 having the above-described configuration may be used as the image pickup device 103. Electrons are accumulated in the image pickup device 103 for a certain period in correspondence to an image formed on the light receiving surface via the optical system 102. A signal corresponding to electrons accumulated in the image pickup device 103 is supplied to the signal processing circuit 104.

The signal processing circuit 104 includes the data processing section 23 and the CDS processing section 24 that each have the above-described configuration, and performs various types of signal processing on a pixel signal output from the image pickup device 103. An image (image data) produced through the signal processing by the signal processing circuit 104 is supplied to the monitor 105 and is displayed thereon, or is supplied to the memory 106 and is stored (recorded) therein.

The above-described configuration of the solid-state image pickup unit 21 is applied to the image pickup unit 101 configured in the above way, thereby the image pickup unit 101 is allowed to perform CDS processing using a signal suitable for the CDS processing, and is thus allowed to obtain a low-noise pixel value similar to a true value. Consequently, the image pickup unit 101 is allowed to acquire an image having a more excellent image quality.

It is to be noted that a process (program) executed by the signal processing circuit 104 is allowed to be installed in the signal processing circuit 104 through a network or a recording medium depending on characteristics of the image pickup device 103, for example, as necessary.

Furthermore, each process described with reference to the above-described flowchart may not be performed on a time series along the order shown in the flowchart, and may include processes performed in parallel or individually (for example, parallel processing or object processing). In addition, the program may be processed by one CPU, or may be subjected to distributed processing by a plurality of CPUs.

It is possible to achieve at least the following configurations from the above-described example embodiments of the disclosure.

(1) A signal processing unit, including:

an extraction section configured to extract variation between a plurality of sampling values obtained through a plurality of sampling operations of signal levels in one or both of a first state and a second state, the first state being a state where floating diffusion is reset, the floating diffusion temporarily accumulating charges transferred from a photodiode performing photoelectric conversion, and the second state being a state where charges generated in the photodiode are accumulated in the floating diffusion; and

a comparison section configured to compare the variation extracted by the extraction section and a predetermined reference value, and to switch, based on a result of the comparison, a signal to be output to a processing section in a subsequent stage.

(2) The signal processing unit according to (1), further including:

a calculation section configured to calculate an average of the plurality of sampling values,

wherein when the variation is smaller than the predetermined reference value, the comparison section outputs the average obtained by the calculation section as the signal to be output to the processing section in the subsequent stage.

(3) The signal processing unit according to (1) or (2), wherein when a plurality of sampling operations of signal levels in the first state are performed, and when variation between a plurality of sampling values of the signal levels in the first state is larger than the predetermined reference value, the comparison section outputs a sampling value of a last-sampled signal level in the first state as the signal to be output to the processing section in the subsequent stage.
(4) The signal processing unit according to any one of (1) to (3), wherein when a plurality of sampling operations of signal levels in the second state are performed, and when variation between a plurality of sampling values of the signal levels in the second state is larger than the predetermined reference value, the comparison section outputs a sampling value of a first-sampled signal level in the second state as the signal to be output to the processing section in the subsequent stage.
(5) The signal processing unit according to any one of (1) to (4), wherein the extraction section obtains, as the variation between the plurality of sampling values, a frequency of occurrence of state change between consecutive sampling values, and

the comparison section compares the frequency of the state change obtained by the extraction section and a predetermined regular frequency, and switches, based on a result of the comparison, the signal to be output to the processing section in the subsequent stage.

(6) The signal processing unit according to any one of (1) to (5), further including:

a calculation section configured to calculate an average of the plurality of sampling values,

wherein when the frequency of the state change is equal to or higher than the predetermined regular frequency, the comparison section outputs the average obtained by the calculation section as the signal to be output to the processing section in the subsequent stage.

(7) The signal processing unit according to any one of (1) to (6), wherein when the frequency of the state change is lower than the predetermined regular frequency, the comparison section outputs, as the signal to be output to the processing section in the subsequent stage, a sampling value of a last-sampled signal level in the first state or a sampling value of a first-sampled signal level in the second state.
(8) The signal processing unit according to any one of (1) to (7), wherein a sampling cycle of the plurality of sampling operations of signal levels is set sufficiently smaller than a time constant of random telegraph signal (RTS) noise generated by transistors configuring a pixel having the photodiode.
(9) A solid-state image pickup unit, including:

a pixel array including pixels arranged in arrays, each pixel having a photodiode performing photoelectric conversion and floating diffusion that temporarily accumulates charges transferred from the photodiode;

a sampling section configured to sample a signal level in a first state and a signal level in a second state, the first state being a state where the floating diffusion is reset, and the second state being a state where charges generated in the photodiode are accumulated in the floating diffusion;

an extraction section configured to extract variation between a plurality of sampling values obtained through a plurality of sampling operations of the signal levels in one or both of the first state and the second state; and

a comparison section configured to compare the variation extracted by the extraction section and a predetermined reference value, and to switch, based on a result of the comparison, a signal to be output to a processing section in a subsequent stage.

(10) An electronic apparatus including a solid-state image pickup unit, the solid-state image pickup unit including:

a pixel array including pixels arranged in arrays, each pixel having a photodiode performing photoelectric conversion and floating diffusion that temporarily accumulates charges transferred from the photodiode;

a sampling section configured to sample a signal level in a first state and a signal level in a second state, the first state being a state where the floating diffusion is reset, and the second state being a state where charges generated in the photodiode are accumulated in the floating diffusion,

an extraction section configured to extract variation between a plurality of sampling values obtained through a plurality of sampling operations of the signal levels in one or both of the first state and the second state; and

a comparison section configured to compare the variation extracted by the extraction section and a predetermined reference value, and to switch, based on a result of the comparison, a signal to be output to a processing section in a subsequent stage.

(11) A signal processing method, including:

extracting variation between a plurality of sampling values obtained through a plurality of sampling operations of signal levels in one or both of a first state and a second state, the first state being a state where floating diffusion is reset, the floating diffusion temporarily accumulating charges transferred from a photodiode performing photoelectric conversion, and the second state being a state where charges generated in the photodiode are accumulated in the floating diffusion; and

comparing the extracted variation and a predetermined reference value, and switching, based on a result of the comparison, a signal to be output to a processing section in a subsequent stage.

(12) A non-transitory tangible recording medium having a program embodied therein, the computer-readable program allowing, when executed by a computer, the computer to execute signal processing, the signal processing including:

extracting variation between a plurality of sampling values obtained through a plurality of sampling operations of signal levels in one or both of a first state and a second state, the first state being a state where floating diffusion is reset, the floating diffusion temporarily accumulating charges transferred from a photodiode performing photoelectric conversion, and the second state being a state where charges generated in the photodiode are accumulated in the floating diffusion; and

comparing the extracted variation and a predetermined reference value, and switching, based on a result of the comparison, a signal to be output to a processing section in a subsequent stage.

It should be understood by those skilled in the art that various modifications, combinations, sub-combinations and alterations may occur depending on design requirements and other factors insofar as they are within the scope of the appended claims or the equivalents thereof.

What is claimed is:

1. A signal processing unit, comprising:
an extraction section configured to extract variation between a plurality of sampling values obtained through a plurality of sampling operations of signal levels in one or both of a first state and a second state, the first state being a state where floating diffusion is reset, the floating diffusion temporarily accumulating charges transferred from a photodiode performing photoelectric conversion, and the second state being a state where charges generated in the photodiode are accumulated in the floating diffusion; and
a comparison section configured to compare the variation extracted by the extraction section and a predetermined reference value, and to switch, based on a result of the comparison, a signal to be output to a processing section in a subsequent stage.

2. The signal processing unit according to claim 1, further comprising:
a calculation section configured to calculate an average of the plurality of sampling values,
wherein when the variation is smaller than the predetermined reference value, the comparison section outputs the average obtained by the calculation section as the signal to be output to the processing section in the subsequent stage.

3. The signal processing unit according to claim 1, wherein when a plurality of sampling operations of signal levels in the first state are performed, and when variation between a plurality of sampling values of the signal levels in the first state is larger than the predetermined reference value, the comparison section outputs a sampling value of a last-sampled signal level in the first state as the signal to be output to the processing section in the subsequent stage.

4. The signal processing unit according to claim 1, wherein when a plurality of sampling operations of signal levels in the second state are performed, and when variation between a plurality of sampling values of the signal levels in the second state is larger than the predetermined reference value, the comparison section outputs a sampling value of a first-sampled signal level in the second state as the signal to be output to the processing section in the subsequent stage.

5. The signal processing unit according to claim 1, wherein the extraction section obtains, as the variation between the plurality of sampling values, a frequency of occurrence of state change between consecutive sampling values, and
the comparison section compares the frequency of the state change obtained by the extraction section and a predetermined regular frequency, and switches, based on a result of the comparison, the signal to be output to the processing section in the subsequent stage.

6. The signal processing unit according to claim 5, further comprising:
a calculation section configured to calculate an average of the plurality of sampling values,
wherein when the frequency of the state change is equal to or higher than the predetermined regular frequency, the comparison section outputs the average obtained by the calculation section as the signal to be output to the processing section in the subsequent stage.

7. The signal processing unit according to claim 5, wherein when the frequency of the state change is lower than the predetermined regular frequency, the comparison section outputs, as the signal to be output to the processing section in the subsequent stage, a sampling value of a last-sampled signal level in the first state or a sampling value of a first-sampled signal level in the second state.

8. The signal processing unit according to claim 1, wherein a sampling cycle of the plurality of sampling operations of signal levels is set sufficiently smaller than a time constant of random telegraph signal (RTS) noise generated by transistors configuring a pixel having the photodiode.

9. A solid-state image pickup unit, comprising:
a pixel array including pixels arranged in arrays, each pixel having a photodiode performing photoelectric conversion and floating diffusion that temporarily accumulates charges transferred from the photodiode;
a sampling section configured to sample a signal level in a first state and a signal level in a second state, the first state being a state where the floating diffusion is reset, and the second state being a state where charges generated in the photodiode are accumulated in the floating diffusion;
an extraction section configured to extract variation between a plurality of sampling values obtained through a plurality of sampling operations of the signal levels in one or both of the first state and the second state; and
a comparison section configured to compare the variation extracted by the extraction section and a predetermined reference value, and to switch, based on a result of the comparison, a signal to be output to a processing section in a subsequent stage.

10. An electronic apparatus including a solid-state image pickup unit, the solid-state image pickup unit comprising:
a pixel array including pixels arranged in arrays, each pixel having a photodiode performing photoelectric conversion and floating diffusion that temporarily accumulates charges transferred from the photodiode;
a sampling section configured to sample a signal level in a first state and a signal level in a second state, the first state being a state where the floating diffusion is reset, and the second state being a state where charges generated in the photodiode are accumulated in the floating diffusion,
an extraction section configured to extract variation between a plurality of sampling values obtained through a plurality of sampling operations of the signal levels in one or both of the first state and the second state; and
a comparison section configured to compare the variation extracted by the extraction section and a predetermined reference value, and to switch, based on a result of the comparison, a signal to be output to a processing section in a subsequent stage.

11. A signal processing method, comprising:
extracting variation between a plurality of sampling values obtained through a plurality of sampling operations of signal levels in one or both of a first state and a second state, the first state being a state where floating diffusion is reset, the floating diffusion temporarily accumulating charges transferred from a photodiode performing photoelectric conversion, and the second state being a state where charges generated in the photodiode are accumulated in the floating diffusion; and
comparing the extracted variation and a predetermined reference value, and switching, based on a result of the comparison, a signal to be output to a processing section in a subsequent stage.

12. A non-transitory tangible recording medium having a program embodied therein, the computer-readable program allowing, when executed by a computer, the computer to execute signal processing, the signal processing comprising:
extracting variation between a plurality of sampling values obtained through a plurality of sampling operations of signal levels in one or both of a first state and a second state, the first state being a state where floating diffusion is reset, the floating diffusion temporarily accumulating charges transferred from a photodiode performing photoelectric conversion, and the second state being a state where charges generated in the photodiode are accumulated in the floating diffusion; and
comparing the extracted variation and a predetermined reference value, and switching, based on a result of the comparison, a signal to be output to a processing section in a subsequent stage.
